(19) United States
(12) Patent Application Publication
(10) Pub. No.: US 2025/0020531 A1
(43) Pub. Date: Jan. 16, 2025

(54) COMPUTER-IMPLEMENTED METHOD FOR COMPENSATING A SENSOR

(71) Applicant: Endress+Hauser SE+Co. KG, Maulburg (DE)

(72) Inventors: Jawad Tayyub, Maulburg (DE); Alexander Vogel, Kirchzarten (DE); Muhammad Sarmad, Islamabad (PK)

(21) Appl. No.: 18/710,436

(22) PCT Filed: Nov. 8, 2022
(86) PCT No.: PCT/EP2022/081085

§ 371 Date: May 15, 2024

(30) Foreign Application Priority Data
Nov. 17, 2021 (DE) 10 2021 130 043.6

(51) Int. Cl. G01L 27/00; G06N 3/08

(52) U.S. Cl. CPC G01L 27/002; G06N 3/08

(57) ABSTRACT

A computer-implemented method for compensating a sensor through machine learning during the manufacturing of the sensor is provided. The first step includes providing a plurality of sensors. The second step includes determining data that have been already collected during the manufacturing and/or compensating of the sensor or the plurality of sensors. The determined data is provided to a neural network configured to determine compensation coefficients. The determined compensation coefficients are saved within the sensor so that the sensor can output compensated sensor values with the help of the determined compensation coefficients.

The present invention relates to a computer-implemented method for compensating a sensor, especially a pressure sensor, through machine learning during the manufacturing of the sensor, a data processing system comprising means for carrying out the method, a computer program, a computer-readable medium as well as a sensor, especially a pressure sensor for use in process and/or automation technology.

Sensors, as for example pressure sensors or also called pressure transducers, are very sensitive to cross influences, as for example temperature. Therefore, these sensors undergo an elaborate compensation process during their manufacturing. Compensation is used to increase and/or to ensure the sensor's accuracy in a given measurement range under given cross influences.

The compensation process is a costly part of the whole manufacturing process. This is because a high number of setpoints are necessary, which are taking the cross influence as well as the measured value of the sensor into account. As for example in case of a pressure transducer and the temperature as cross influence, a high number of temperature and pressure setpoints are needed to approximate the analytical relation between the sensor output and the actual pressure value. As one can imagen, to set/generate this setpoints a lot of time is needed. In case of the before given example a temperature chamber is typically used to set the various temperature points, so that a corresponding pressure value can be measured with the sensor. Ordinarily, at least two temperature cycles, i.e. at 80° C. and −20° C. are set with the temperature chamber. Minimizing the time needed for this process ensures lower manufacturing costs as well as less energy consumption, since heating and cooling is not only time-consuming but also creates a large CO₂ footprint.

Therefore, the objective technical problem underlaying the present invention is to reduce the time which is needed to compensate a sensor during its manufacturing.

The object is achieved by the computer-implemented method according to claim 1, the data processing system according to claim 10, the computer program according to claim 11, as the computer-readable medium according to claim 12 as well as a sensor for use in process and/or automation technology.

With respect to the method, the objective technical problem is solved by a computer-implemented method for compensating a sensor, especially a pressure sensor, through machine learning during the manufacturing of the sensor, the method comprising at least the steps of:
Providing a plurality of sensors, especially a plurality of pressure sensors that have already been manufactured and/or compensated;
Determining data that have been already collected during the manufacturing and/or compensating of the sensor or the plurality of sensors, especially the pressure sensor or the plurality of pressure sensors;
Providing the determined data to a neural network configured to determine compensation coefficients, especially compensation coefficients for the pressure sensor or to provide a look-up table;
Saving the determined compensation coefficients within the sensor, especially the pressure sensor, so that the sensor can output compensated sensor values with the help of the determined compensation coefficients.

Neural networks (NN), belonging to the field of machine learning, are based on a plurality of interconnected units called artificial neurons which are typically organized in various layers and are able to detect complex and nonlinear relationships. With respect to the present invention, the use of a neural network for determining compensation coefficients for a sensor, especially for a pressure transducer results in a less time-consuming compensation process. For the purpose of this application, compensation coefficients are understood to mean coefficients of a compensation equation that is used for calculating the compensated sensor output (via the sensor).

A preferred embodiment of the method according to the present invention provides that the compensation coefficients are determined for a given first function via the neuronal network. Especially the given first function is a polynomial function. A high-order polynomial/polynomial function is a good choice for their low memory footprint on the memory/ASIC of the sensor. As for example a polynomial function in the form of s=c₀·p(T)+c₁·p(T)·T+c₂ can be used, wherein c₀, c₁, c₂ are the coefficient to be determined, T is a specific temperature and p(T) is the sensor value read out by the sensor at the specific temperature.

A further preferred embodiment of the method according to the present invention provides that at least a further function, preferably a linear or polynomial function, is given, which normalizes/scales a measuring raw value of the sensor, especially a pressure or temperature raw value of the pressure sensor, to a normalized/scaled measuring value, preferably a normalized/scaled pressure or temperature value.

A further preferred embodiment of the method according to the present invention provides that further coefficients for the at least further function are determined using a further neural network, especially a hypernetwork NN_{T}.

A further preferred embodiment of the method according to the present invention provides that normalized/scaled measuring values of the sensor, especially normalized/scaled pressure or temperature values of the pressure sensor, are calculated with the help of the further given function and/or the further coefficients and wherein the calculated normalized/scaled measuring values, especially the normalized/scaled pressure or temperature values are used as data provided to the neuronal network for determining the compensation coefficients.

A further preferred embodiment of the method according to the present invention provides that as data data is used that was determined during previous manufacturing steps of the sensor, especially the pressure sensor, as for example physical parameters of a measuring element, a resistance value, and/or a capacity value of the sensor.

A further preferred embodiment of the method according to the present invention provides that the neuronal network is trained before the compensation coefficients are determined.

A further preferred embodiment of the method according to the present invention provides that for training the neuronal network historical data from the entire production line and/or data from subsequent manufacturing steps after the compensation of the plurality of pressure sensors that have already been manufactured and/or compensated are used.

The objective technical problem is also achieved by means of a data processing system comprising means for carrying out the method according to the present invention.

The objective technical problem is also achieved by a computer program comprising instructions which, when the program is executed by a computer, cause the computer to carry out the steps of the method according to the present invention, by a computer-readable medium comprising instructions which, when executed by a computer, cause the computer to carry out the method according to the present invention and finally, by a sensor, especially a pressure sensor for use in process and/or automation technology comprising a memory having saved the determined coefficients according to the method and wherein the sensor, especially the pressure sensor is adapted to output a compensated sensor value, especially a compensated pressure value using the determined coefficients.

It shall be noted that the embodiments described in connection with the method are mutatis mutandis applicable to the data processing system, the computer program, the computer-readable medium as well as the sensor, especially the pressure sensor.

The invention will be explained in more detail with reference to the following figures.

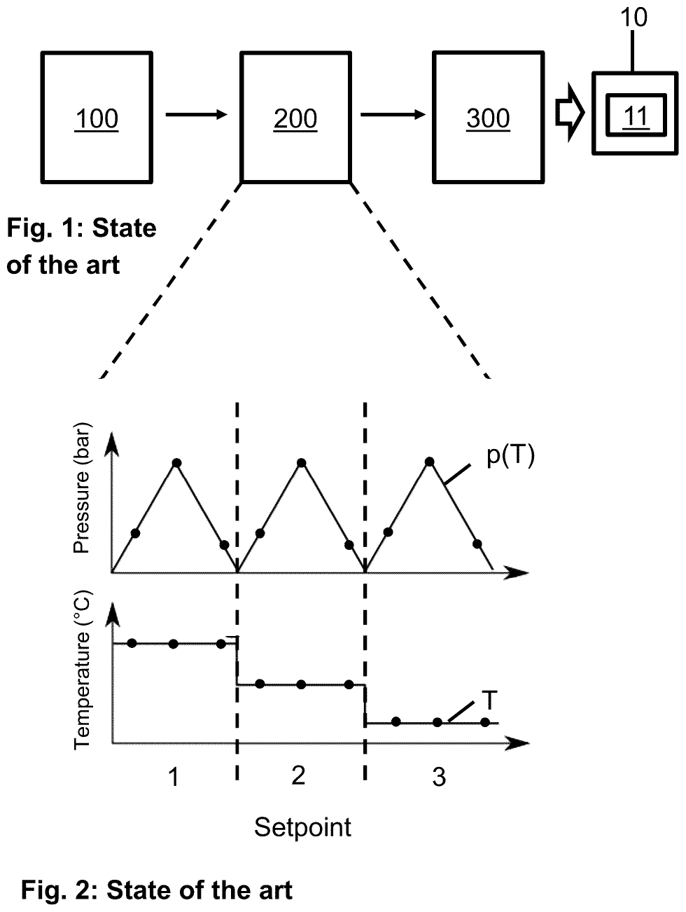

FIG. 1 illustrates a manufacturing process of a pressure sensor according to the prior art,

FIG. 2 shows a diagram with pressure and temperature values that a pressure sensor is subject to during a compensation process according to the prior art,

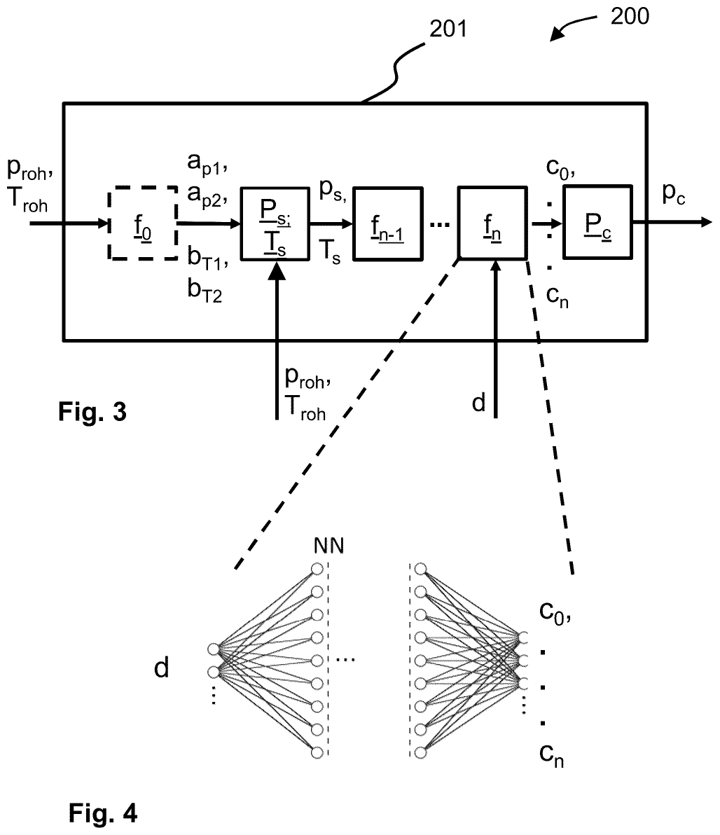

FIG. 3 shows a block diagram of an embodiment of the method according to the present invention including an optional pre-scaling or normalization step, and

FIG. 4 shows schematically a neuronal network according to the invention,

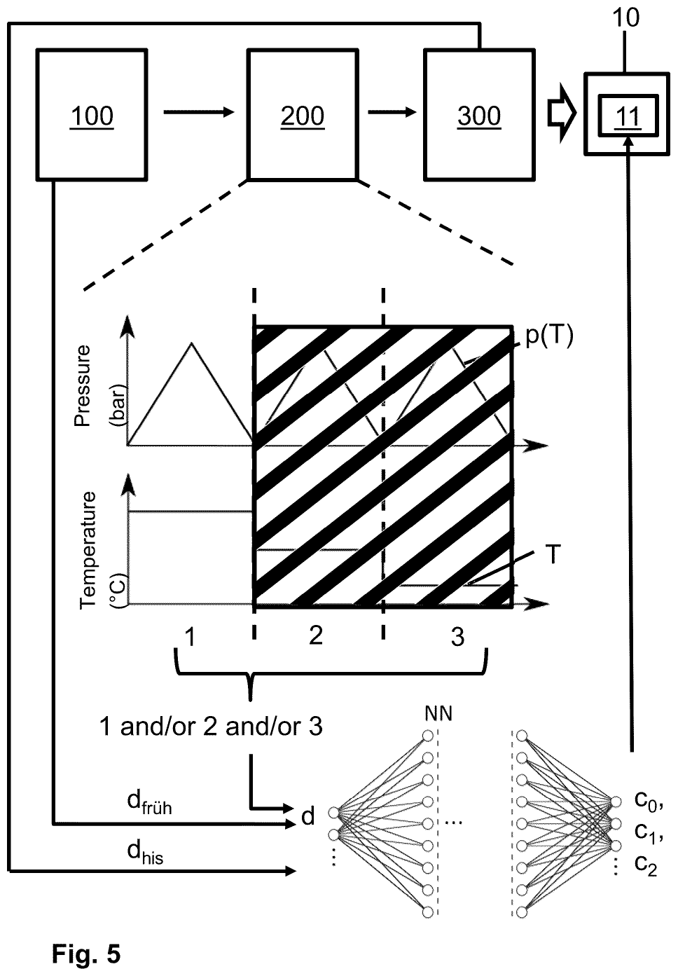

FIG. 5 shows schematically a preferred embodiment according to the invention, wherein the manufacturing process of a specific pressure sensor is shown as well as the training process of the neuronal network.

The further description of the invention is illustrated by means of a pressure sensor, since pressure sensors are the most prevalent sensor type in use. However, the invention is not limited to pressure sensor at all.

FIG. 1 illustrates schematically a manufacturing process of a pressure sensor according to the prior art. At manufacturing step 100 all steps before compensating the pressure sensor are summarized. This includes the manufacturing of the individual components of the pressure sensor, as for example the sensor element and the sensor electronic, as well as the assembly of the individual components to the pressure sensor. At manufacturing step 200 the compensation step takes place. During this compensation step 200 a lot of temperature and pressure setpoints p(T), T are needed to approximate the analytical relation between the sensor output and the actual pressure value.

FIG. 2 shows a diagram with setpoints (each setpoint consist of one temperature value T and a corresponding pressure value p(T)), which are used to compensate a pressure sensor according to the prior art. In total, there are three different temperature cycles, i.e. +80° C., +25° C. and −20° C. having three pressure points within each cycle. Out of this setpoints coefficients for a polynomial equation are determined. These coefficients are used to capture the analytical relation between the sensor outputs and true value. A high-order polynomial/polynomial function is a good choice for their low memory footprint on the memory/ASIC of the sensor. As for example a polynomial function in the form of s=c₀·p(T)+c₁·p(T)·T+c₂ can be used, wherein c₀, c₁, c₂ are the coefficient to be determined, T is a specific temperature and p(T) is the pressure value read out by the pressor sensor at the specific temperature. As one can see from FIG. 2 the method according to the prior art requires the acquisition of multiple set points at high, mid, and low temperatures. These setpoints are selected to encompass the operational range of the sensor for calculating the coefficients of the polynomial. Skipping any of these set points can lead to poor polynomial performance at those set points, as it is the case for the provided example in the explained compensation process according to the prior art.

FIGS. 3 to 5 show a computer-implemented method for compensating a pressure sensor 10 through machine learning during the manufacturing of the pressure sensor 100, 200, 300. According to the invention these compensation points can be reduced by removing setpoints of at least one entire temperature cycle, in FIG. 5 removing two temperature cycles is symbolized by the two grayed out areas 2 and 3. However, it does not necessarily have to be the two right-hand areas.

A sub-step toward the compensation step is the scaling or normalization step. For this optionally sub-step a mathematical function f₀ is used to normalize or scale a measuring raw value, like p_{raw} and/or T_{raw}, for the pressure sensor.

The mathematical function, which is used, depends on the kind of the pressure sensor (e.g. capacitive or resistive pressure sensor) and can be for example a linear or a polynomial function. For the further explanations a linear function is used for the pressure scaling and can be for example in the following form:

$${p}_{s} = {a}_{p 1} \times {p}_{raw} + {a}_{p 2} \qquad ( 1 )$$

For determining the coefficients aₚ₁ and aₚ₂, a ground truth pressure per can be converted to obtain a scaled ground truth pressure p_{sg} in the same unit as raw pressure p_{raw}. Afterwards a least-squares-algorithm can be used to fit the raw pressure p_{raw} and the scaled ground truth pressure p_{sg} to determine the coefficients aₚ₁ and aₚ₂ of the pressure scaling equation 1 in a determined or overdetermined measurement set. This function can then be used to convert raw pressure values p_{raw} to scaled pressure values p_{sg}.

Additionally, or alternative a temperature scaling or normalization can be performed in the sup-step using e.g. the following equation:

$${T}_{S} = {b}_{T 1} \times {T}_{raw} + {b}_{T 2} \qquad ( 2 )$$

For normalizing the raw temperature values T_{raw} a local min-max normalization procedure to obtain normalized raw temperature T_{S} can be used. This normalization scheme can use raw temperature points T_{raw} from each sensor in the training dataset to calculate the minimum and maximum value of the respective quantity. These values can then be used to normalize T_{raw} to obtain T_{S} for each sensor. Only the M points of the not skipped temperature cycles from the raw temperature values T_{raw} are processed in the forward pass of a scaling hypernetwork NN_{T} to predict the scaling polynomial coefficients b_{T1} and b_{T2}. The temperature scaling polynomial in equation 2 is provided with all N points of raw temperature values T_{raw} to obtain scaled temperature values T_{S}. The hypernetwork NN_{T} can be a polynomial hypernetwork, which is preferably trained, as shown in FIG. 5 and explained below.

The determined pressure and temperature scaling coefficients are used for the corresponding scaling function for obtaining pₛ, Tₛ, which are stored in the pressure sensor at this manufacturing step 200. For sake of clarity in FIG. 3 one box is shown for the pressure and temperature scaling function.

After the sub step of scaling or normalization further steps (fₙ₋₁) can optionally be performed bevor according to the invention the coefficients c₀-cₙ of a compensating function are being determined using a neuronal network or a compensation look-up table is provided by the neuronal network. These optional steps can be for example that the output values, which are calculated with the help of the scaling function(s), are passed through a global min-max norm and/or a Fourier mapping fₙ₋₁. In FIG. 3 these optional steps are symbolized with the reference sign fₙ₋₁ as well as the three points ( . . . ).

After these steps according to the invention the determination of the coefficients c₀-cₙ of a compensating function takes place. For this step a neuronal network, preferred a convolutional neuronal network, is used to predict the coefficients c₀-cₙ for a given compensation function or a compensation look-up table. In a preferred embodiment the first half of the neuronal network architecture consists of 1D convolution layers “conv1D1” to “conv1D3” and in the second half maxpool layer (“maxpool”) and linear layers (“Linear1” to “Linear3”) are used. The dimensions of the input to “conv1D1” i.e. Mₚ can be 2 in case of two inputs like temperature and pressure as it is explained in the embodiment before. Alternative, Mₚ can also be higher than 2, e.g., in case of performing further steps (fₙ₋₁) as for example a Fourier mapping. The output of “Linear3” i.e. Cₙ represents the number of the coefficients necessary for a compensating or a scaling function (e.g. Cₙ=2 for the temperature scaling function or Cₙ=10 for the compensating function of this example). The filter of maxpool layer is adaptable to input size Iₛ, whereas Input size Iₛ is the number of measurement points that will be removed later. A preferred architecture of the neuronal network is summarized in the following table:

| Name | Kernel | Ch I/O | Input Res | Out Res | Input |
|---|---|---|---|---|---|
| conv1D1 | 1 | Mₚ/64 | Iₛ | Iₛ | Sensor values |
| conv1D2 | 1 | 64/128 | Iₛ | Iₛ | conv1D1 |
| conv1D3 | 1 | 128/1024 | Iₛ | Iₛ | conv1D2 |
| maxpool | Iₛ | 21024/1 | — | — | conv1D3 |
| Linear1 | — | 1024/512 | — | — | maxpool |
| Linear2 | — | 1025/256 | — | — | Linear1 |
| Linear3 | — | 256/Cₙ | — | — | Linear2 |

However, the invention is not limited to the specific dimensions for the in- or output, nor to this specific network layout.

The given function (compensation function) in this case preferably is a high-order polynomial/polynomial function with the compensation coefficients c₀-cₙ. As for example the given function (compensation function) can be:

$${p}_{c} = {c}_{0} \times {p}_{s}^{4} + {c}_{1} \times {p}_{s}^{3} + {c}_{2} \times {p}_{s}^{2} \times {T}_{s} + {c}_{3} \times {p}_{s}^{2} + {c}_{4} \times {p}_{s} \times {T}_{s}^{2} + {c}_{5} \times {p}_{s} \times {T}_{s} + {c}_{6} \times {p}_{s} + {c}_{7} \times {T}_{s}^{2} + {c}_{8} \times {T}_{s} + {c}_{9} \qquad ( 3 )$$

To predict the compensation coefficients c₀-cₙ data is determined, which is feed to neuronal network. As can be seen in FIG. 5 the data can be previous data dₚᵣₑᵥ that have already been collected during previous manufacturing steps of the current pressor sensor that is being manufactured, e.g. membrane thickness of a measuring membrane of the pressor sensor, basic/ground capacity of the measuring capacity in case of a capacitive pressor sensor, etc.

In a preferred embodiment of the invention normalized/scaled pressure and/or temperature values pₛ, Tₛ of the pressure sensor that is being manufactured are also used as data to feed the neuronal network, as can be seen in FIG. 5. For getting the normalized/scaled pressure and/or temperature values pₛ, Tₛ the current sensor uses the equation (1) and/or (2) together with the corresponding coefficients that have been determined before.

Optionally, for training historical data dₕᵢₛ from subsequent manufacturing steps after the compensation of the plurality of pressure sensors that have already been manufactured and/or compensated may be used, as can be seen in FIG. 5.

In a last step according to the invention the determined compensation coefficients c₀-cₙ are saved/stored in the pressure sensor that is being manufactured. The saving/storing can be for example occur in separate memory chip of the sensor or integrated in an ASIC or a microprocessor of the pressor sensor. The saving/storing is symbolized in FIG. 5 with an arrow from the determined compensation coefficients c₀-cₙ to the pressure sensor 10, e.g. the memory 11.

After the manufacturing (including the compensation step) has been finished for the current pressure sensor it can be used, e.g. in a process and/or automation plant, to output the compensated pressure values p_{c}. For this purpose, the pressure sensor 10 is arranged to internally provide raw pressure and temperature p_{raw}, T_{raw} values. These values are internally, e.g. with a microprocessor, scaled to form pₛ and Tₛ using the internally stored scaling polynomial function with the corresponding coefficients. The scaled values can internally be optionally normalized with the help of a further normalization function and passed to the stored compensation polynomial function with the corresponding coefficients to obtain the final compensated pressure p_{c}, which are outputted by the pressor sensor.

### REFERENCE SYMBOLS

10 Pressure Sensor
11 Memory
100 Pre manufacturing step
200 Calibration or compensation step during manufacturing
201 Data processing system
300 Post manufacturing step
NN Neuronal network
NN_{T} Further neural network, especially hypernetwork
aₚ₁, aₚ₂, Pressure scaling coefficients
b_{T1}, b_{T2} Temperature scaling coefficients
d Data used for training the neuronal network
c₀ . . . cₙ Coefficients of the compensation polynomial equation
p(T) Pressure value
T Temperature value
f₀ at least a further function
fₙ₋₁ first function
fₙ given first function, especially a high-order polynomial function
pₛ, Tₛ calculated normalized/scaled measuring values
dₕᵢₛ historical training data from already manufactured sensors
dₚᵣₑᵥ data that was determined during previous manufacturing steps of the sensor
p_{raw} Not compensated “raw” pressure output
T_{raw} Not compensated “raw” temperature output
p_{c} Compensated pressure value
p_{sg} Scaled ground truth
M p/T points used for scaling/compensation
N All p/T points used in training

1-14. (canceled)

15. A computer-implemented method for compensating a sensor through machine learning during the manufacturing of the sensor, the method comprising at least the steps of:
providing a plurality of sensors;
determining data that have been already collected during the manufacturing and/or compensating of the sensor or the plurality of sensors;
providing the determined data to a neural network configured to determine compensation coefficients;
saving the determined compensation coefficients within the sensor so that the sensor can output compensated sensor values with the help of the determined compensation coefficients.

16. The computer-implemented method according to claim 15, wherein the compensation coefficients are determined for a given first function via the neuronal network.

17. The computer-implemented method according to claim 16, wherein the given first function is a polynomial function.

18. The computer-implemented method according to claim 15, wherein at least a further function is given, which normalizes/scales a measuring raw value of the sensor to a normalized/scaled measuring value.

19. The computer-implemented method according to claim 15, wherein further coefficients for the at least further function are determined using a further neural network.

20. The computer-implemented method according to claim 18, wherein normalized/scaled measuring values of the sensor are calculated with the help of the further given function and/or the further coefficients and wherein the calculated normalized/scaled measuring values are used as data provided to the neuronal network for determining the compensation coefficients.

21. The computer-implemented method according to claim 15, wherein data is used that was determined during previous manufacturing steps of the sensor.

22. The computer-implemented method according to claim 15, wherein the neuronal network is trained before the compensation coefficients are determined.

23. The computer-implemented method according to claim 22, wherein for training the neuronal network historical data from the entire production line and/or data from subsequent manufacturing steps after the compensation of the plurality of pressure sensors that have already been manufactured and/or compensated are used.

24. A data processing system for carrying out a method including the steps of:
providing a plurality of sensors;
determining data that have been already collected during the manufacturing and/or compensating of the sensor or the plurality of sensors;
providing the determined data to a neural network configured to determine compensation coefficients;
saving the determined compensation coefficients within the sensor so that the sensor can output compensated sensor values with the help of the determined compensation coefficients.

25. A computer program comprising instructions which, when the program is executed by a computer, cause the computer to carry out the following method steps:
providing a plurality of sensors;
determining data that have been already collected during the manufacturing and/or compensating of the sensor or the plurality of sensors;
providing the determined data to a neural network configured to determine compensation coefficients;
saving the determined compensation coefficients within the sensor so that the sensor can output compensated sensor values with the help of the determined compensation coefficients.

26. A computer-readable medium comprising instructions which, when executed by a computer, cause the computer to carry out the following method steps:
providing a plurality of sensors;
determining data that have been already collected during the manufacturing and/or compensating of the sensor or the plurality of sensors;
providing the determined data to a neural network configured to determine compensation coefficients;
saving the determined compensation coefficients within the sensor so that the sensor can output compensated sensor values with the help of the determined compensation coefficients.

27. A sensor comprising a memory having saved coefficients and a sensor adapted to output a compensated sensor value using the coefficients, wherein the coefficients are determined using the following method steps:
providing a plurality of sensors;
determining data that have been already collected during the manufacturing and/or compensating of the sensor or the plurality of sensors;
providing the determined data to a neural network configured to determine compensation coefficients;
saving the determined compensation coefficients within the sensor so that the sensor can output compensated sensor values with the help of the determined compensation coefficients.

28. A method for operating a sensor, wherein the sensor uses determined coefficients to output a compensated pressure value, the method including:
providing a plurality of sensors;
determining data that have been already collected during the manufacturing and/or compensating of the sensor or the plurality of sensors;
providing the determined data to a neural network configured to determine compensation coefficients;
saving the determined compensation coefficients within the sensor so that the sensor can output compensated sensor values with the help of the determined compensation coefficients.
